(19) United States
(12) Patent Application Publication
(10) Pub. No.: US 2015/0281947 A1
(43) Pub. Date: Oct. 1, 2015

(54) METHOD AND APPARATUS FOR FAST IP ADDRESS ASSIGNMENT

(71) Applicant: QUALCOMM Incorporated, San Diego, CA (US)

(72) Inventors: Abhishek Pramod Patil, San Diego, CA (US); Santosh Paul ABRAHAM, San Diego, CA (US); George CHERIAN, San Diego, CA (US)

(21) Appl. No.: 14/668,709

(22) Filed: Mar. 25, 2015

Related U.S. Application Data
(60) Provisional application No. 61/970,571, filed on Mar. 26, 2014.

(51) Int. Cl. H04W 8/26; H04W 72/04; H04L 29/12

(52) U.S. Cl. CPC H04W 8/26; H04L 61/2015; H04W 72/0406

(57) ABSTRACT

A particular method includes receiving, at an access point, a set up message from a station. The set up message requests allocation of an internet protocol (IP) address. The method further includes selecting an available IP address from a pool of available IP addresses to assign to the station based on the set up message. The method further includes assigning the available IP address to the station as an assigned IP address. The method also includes transmitting a set up response to the station. The set up response identifies the assigned IP address.

### I. CLAIM OF PRIORITY

The present application claims priority from U.S. Provisional Patent Application No. 61/970,571 entitled “FAST IP ADDRESS ASSIGNMENT VIA IP CACHING AT AN 802.11AI AP,” filed Mar. 26, 2014, the contents of which are incorporated by reference in their entirety.

### II. FIELD

The present disclosure is generally related to an internet protocol (IP) address assignment system.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), tablet computers, and paging devices that are small, lightweight, and easily carried by users. Many such computing devices include other devices that are incorporated therein. For example, a wireless telephone can also include a digital still camera, a digital video camera, a digital recorder, and an audio file player. Also, such computing devices can process executable instructions, including software applications, such as a web browser application that can be used to access the Internet and multimedia applications that utilize a still or video camera and provide multimedia playback functionality. As such, these wireless telephones can include significant computing capabilities.

The Institute of Electrical and Electronics Engineers (IEEE) has promulgated various industry specifications related to wireless networking, many of which are designated with the “IEEE 802.11” name. Typically, before a specification is drafted, a study group and/or task group is formed to evaluate the interest and feasibility of particular wireless technology. For example, the “ai” task group (referred to as TGai or IEEE 802.11ai) is related to fast initial link setup (FILS). One goal of TGai is to reduce latency corresponding to an association process between a station and an access point. The association process includes providing the station with an internet protocol (IP) address. TGai defines FILS Secure Container information elements (IEs) which may be used for IP address assignment, carrying domain name system (DNS) messages, and carrying key information. Two elements that may be used to request an IP address are: FILS higher layer packet (HLP) container elements and FILS IP address assignment elements carrying an IP address data field for request. The elements may be used by a station to request an IP address from a dynamic host configuration protocol (DHCP) server (e.g., via the access point). The request may follow a DHCP rapid commit protocol (e.g., a two-way handshake) or may not follow the DHCP rapid commit protocol (e.g., another DHCP protocol that uses a four-way handshake). However, DHCP response delay may be large (e.g., 0.5 seconds when the request follows the DHCP rapid commit protocol and 1.3 seconds when the request does not follow the DHCP rapid commit protocol) as compared to a signal transmission time between the station and an access point.

### IV. SUMMARY

This disclosure presents embodiments of an internet protocol (IP) address assignment system. An access point of the IP address assignment system may store a set of communication addresses that are used for IP address cache pre-population. For example, the access point may store multiple private media access control (MAC) addresses and request multiple IP addresses from a dynamic host configuration protocol (DHCP) server. Each of the multiple IP addresses may correspond to one of the multiple private MAC addresses. As used herein, the term “private MAC address” refers to a valid MAC address (e.g., a unique identifier used for network communication on a physical network segment) stored at the access point. A private MAC address is an auxiliary MAC address that is distinct from a MAC address used by the access point to communicate with the DHCP server. A private MAC address may be used for the purposes of gathering IP addresses at the access point, for the purposes of DHCP communications, or for another purpose where a MAC address is used. For example, the access point may generate a set of private MAC addresses to obtain a set of IP addresses that may be assigned to stations. Thus, the access point may receive the multiple IP addresses from the DHCP server and assign the multiple IP addresses to a pool of IP addresses at the access point. The access point may assign IP addresses from the pool of IP addresses to stations that make an IP address request (e.g., by intercepting an IP address request from the station to the DHCP) as part of an association process. The access point may assign an IP address to a station more quickly, as compared to an access point that requests an IP address from a DHCP server in response to receiving an IP address request from the station. Thus, the station may complete the association process more quickly, as compared to a station connected to an access point of another IP address assignment system.

In a particular embodiment, a method for fast internet protocol (IP) address assignment in a wireless communication network includes receiving, at an access point, a set up message from a station. In the particular embodiment, the setup message is requesting allocation of an IP address to the station. The method also includes selecting, at the access point, an available IP address from a pool of available IP addresses to assign to the station based on the set up message. The method also includes assigning, at the access point, the available IP address to the station as an assigned IP address. The method further includes transmitting, from the access point, a set up response to the station. In the particular embodiment, the set up response is identifying the assigned IP address.

In another particular embodiment, an apparatus includes a processor and a memory storing instructions executable by the processor to perform operations. The operations include receiving, at an access point, a set up message from a station. In the particular embodiment, the set up message is requesting allocation of an internet protocol (IP) address to the station. The operations also include selecting, at the access point, an available IP address from a pool of available IP addresses to assign to the station based on the set up message. The operations further include assigning, at the access point, the available IP address to the station as an assigned IP address. The operations also include transmitting, from the access point, a set up response to the station. In the particular embodiment, the set up response is identifying the assigned IP address.

In another particular embodiment, an apparatus includes means for receiving a set up message at an access point. In the particular embodiment, the set up message is requesting allocation of an internet protocol (IP) address to a station. The apparatus also includes means for selecting an available IP address from a pool of available IP addresses to assign to the station based on the set up message. The apparatus further includes means for assigning the available IP address to the station as an assigned IP address. The apparatus also includes means for transmitting a set up response to the station. In the particular embodiment, the set up response is identifying the assigned IP address. According to the particular embodiment, the pool of available IP addresses corresponds to a portion of a memory coupled to the means for selecting the available IP address.

In another particular embodiment, a non-transitory computer readable medium includes instructions for fast internet protocol (IP) address assignment in a wireless communication network. The instructions, when executed by a processor at an access point, cause the processor to receive a set up message from a station. In the particular embodiment, the set up message is requesting allocation of an IP address to the station. The instructions are also executable to cause the processor to select an available IP address from a pool of available IP addresses to assign to the station based on the set up message. The instructions are further executable to cause the processor to assign the available IP address to the station as an assigned IP address. The instructions are also executable to cause the processor to transmit a set up response to the station. In the particular embodiment, the set up response is identifying the assigned IP address.

In another particular embodiment, a method includes transmitting, from an access point to a dynamic host configuration protocol (DHCP) server, multiple DHCP requests. The method further includes receiving, at the access point from the DHCP server, multiple internet protocol (IP) addresses, each IP address corresponding to a DHCP request of the multiple DHCP requests. The method further includes assigning the multiple IP addresses to a pool of available IP addresses at the access point.

In another particular embodiment, a method includes receiving, at an access point, a set up message from a station. The set up message requests allocation of an internet protocol (IP) address. The method further includes selecting an available IP address from a pool of available IP addresses to assign to the station based on the set up message. The method further includes assigning the available IP address to the station as an assigned IP address. The method also includes transmitting a set up response to the station. The set up response identifies the assigned IP address.

In another particular embodiment, an apparatus includes a processor and a memory accessible by the processor. The memory includes instructions executable by the processor to send, from an access point to a dynamic host configuration protocol (DHCP) server, multiple DHCP requests. The memory further includes instructions executable by the processor to receive, at the access point from the DHCP server, multiple internet DHCP request of the multiple DHCP requests. The memory further includes instructions executable by the processor to assign the multiple IP addresses to a pool of available protocol (IP) addresses, each IP address of the multiple IP addresses corresponding to an IP addresses at the access point.

In another particular embodiment, an apparatus includes a processor and a memory that stores instructions that are executable by the processor to perform operations. The operations include receiving, at an access point, a set up message from a station. The set up message requests allocation of an internet protocol (IP) address. The operations further include selecting an available IP address from a pool of available IP addresses to assign to the station based on the set up message. The operations further include assigning the available IP address to the station as an assigned IP address. The operations also include transmitting a set up response to the station. The set up response identifies the assigned IP address.

In another particular embodiment, an apparatus includes means for transmitting, from an access point to a dynamic host configuration protocol (DHCP) server, multiple DHCP requests. The apparatus further includes means for receiving, at the access point from the DHCP server, multiple internet protocol (IP) addresses, each IP address of the multiple IP addresses corresponding to a DHCP request of the multiple DHCP requests. The apparatus further includes means for assigning the multiple IP addresses to a pool of available IP addresses at the access point.

In another particular embodiment, an apparatus includes means for receiving a set up message at an access point. The set up message requests allocation of an internet protocol (IP) address to a station. The apparatus also includes means for selecting an available IP address from a pool of available IP addresses to assign to the station based on the set up message. The apparatus further includes means for assigning the available IP address to the station as an assigned IP address. The apparatus also includes means for transmitting a set up response to the station. The set up response identifies the assigned IP address.

In another particular embodiment, a non-transitory computer readable medium includes instructions that, when executed by a processor, cause the processor to initiate transmitting, from an access point to a dynamic host configuration protocol (DHCP) server, multiple DHCP requests. The non-transitory computer readable medium further includes instructions that, when executed by the processor, cause the processor to initiate receiving, at the access point from the DHCP server, multiple internet protocol (IP) addresses, each IP address of the multiple IP addresses corresponding to a DHCP request of the multiple DHCP requests. The non-transitory computer readable medium further includes instructions that, when executed by the processor, cause the processor to assign the multiple IP addresses to a pool of available IP addresses at the access point.

In another particular embodiment, a non-transitory computer readable medium includes instructions for fast internet protocol (IP) address assignment in a wireless network. The instructions, when executed by a processor at an access point, cause the processor to perform operations. The operations include receiving a set up message from a station. The set up message requests allocation of an internet protocol (IP) address. The operations further include selecting an available IP address from a pool of available IP addresses to assign to the station based on the set up message. The operations further include assigning the available IP address to the station as an assigned IP address. The operations also include transmitting a set up response to the station. The set up response identifies the assigned IP address.

One particular advantage provided by at least one of the disclosed embodiments is that an access point of the IP address assignment system may assign an IP address to a station more quickly, as compared to an access point that requests an IP address from a DHCP server, in response to receiving an IP address request from the station.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram that illustrates a particular embodiment of an access point of an internet protocol (IP) address assignment system;

FIG. 2 is a diagram depicting a particular embodiment of an IP address assignment system;

FIG. 3 is a diagram depicting another particular embodiment of an IP address assignment system;

FIG. 4 is a flow chart that illustrates a particular embodiment of a method of configuring an IP address assignment system;

FIG. 5 is a flow chart that illustrates a particular embodiment of a method of operating an IP address assignment system; and

FIG. 6 is a block diagram that illustrates a particular embodiment of a communication device including IP address request logic.

### VI. DETAILED DESCRIPTION

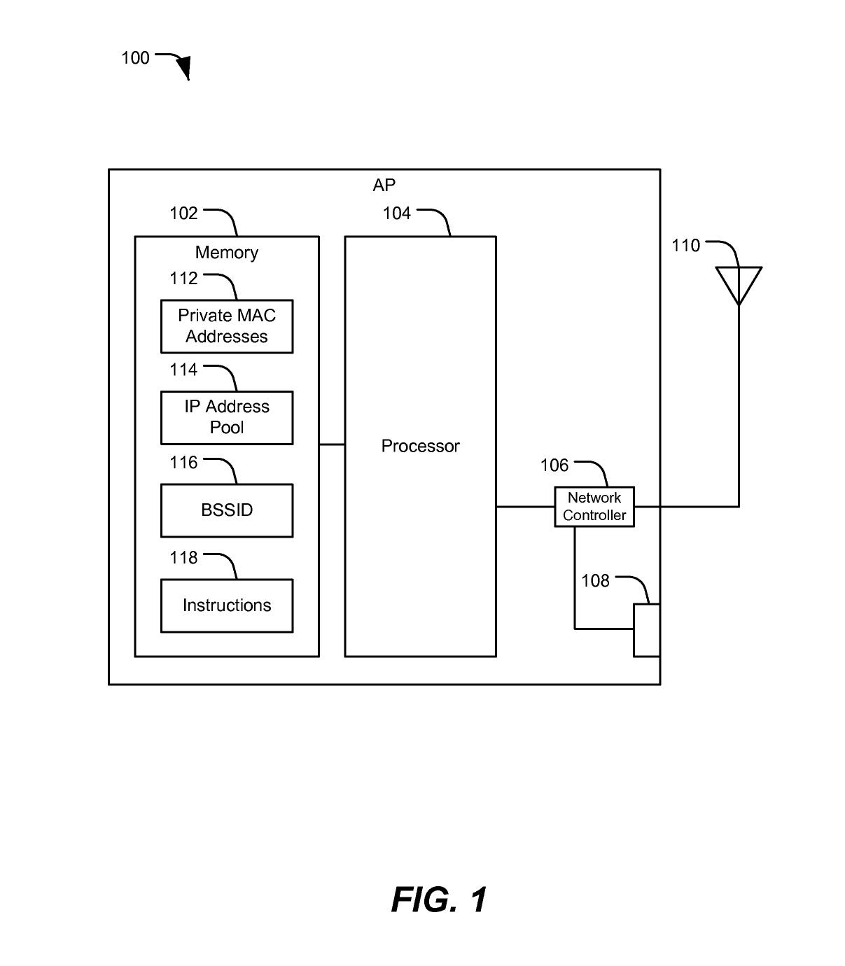

Referring to FIG. 1, a block diagram depicts a particular illustrative embodiment of an access point 100 of an internet protocol (IP) address assignment system. The access point 100 includes a memory 102 (e.g., a non-transitory computer readable medium), a processor 104, a network controller 106, and a network interface 108 (e.g., a connection point that corresponds to a wired network). An antenna 110 may be internal to the access point 100 or may be external to the access point 100. The memory 102 may include (e.g., comprise) a list of private media access control (MAC) addresses 112, an IP address pool 114, a basic service set identification (BSSID) 116 that corresponds to the access point 100, and instructions 118 configured to be executed by the processor 104.

The access point 100 may store a set of communication addresses that are used for IP address cache pre-population. For example, the access point 100 may store multiple private MAC addresses and request multiple IP addresses from a dynamic host configuration protocol (DHCP) server. Each of the multiple IP addresses may correspond to one of the multiple private MAC addresses. As used herein, the term “private MAC address” refers to a valid MAC address (e.g., a unique identifier used for network communication on a physical network segment) stored at the access point 100. A private MAC address is an auxiliary MAC address that is distinct from a MAC address used by the access point 100 to communicate with the DHCP server. A private MAC address may be used for the purposes of gathering IP addresses at the access point 100, for the purposes of DHCP communications, or for another purpose where a MAC address is used. In a particular embodiment, the private MAC addresses are generated (e.g., by the processor 104 by executing a portion of the instructions 118) based on the BSSID 116. Thus, the techniques described herein support generating, at the access point, at least one private MAC address using a basic service set identification (BSSID) of the access point. For example, the access point 100 may generate a set of private MAC addresses to obtain a set of IP addresses that may be assigned to stations. In another particular embodiment, the private MAC addresses are assigned to the access point 100 (e.g., by a manufacturer or a vendor). For example, the access point 100 may receive, from a vendor, a set of private MAC addresses to obtain a set of IP addresses that may be assigned to stations. Thus, in one embodiment, at least one private MAC address is assigned to the access point by a vendor.

The list of private MAC addresses 112 may be used to populate the IP address pool 114. For example, the processor 104 may initiate, by executing a portion of the instructions 118, transmitting (e.g., via the network controller 106 and the antenna 110 or via the network controller 106 and the network interface 108) multiple DHCP requests to a DHCP server. Each DHCP request may include a corresponding private MAC address of the list of private MAC addresses 112. In this example, based on each DHCP request, the processor 104 may receive a corresponding IP address. To illustrate, the processor 104 may receive one or more IP addresses via the network controller 106 and the antenna 110 or via the network controller 106 and the network interface 108 by executing a portion of the instructions 118. In this example, the processor 104 may assign, by executing a portion of the instructions 118, each IP address to the IP address pool 114 (e.g., populating the IP address pool 114). The IP address pool 114 may correspond to a location within the memory 102. Thus, in a particular embodiment, the pool of available IP addresses corresponds to a portion of the memory.

Based on the instructions 118, the processor 104 may receive (e.g., via the network controller 106 and the antenna 110 or via the network controller 106 and the network interface 108) a set up message. For example, the set up message may be received from a station that requests allocation of an IP address to the station. The set up message may be a fast initial link setup (FILS) higher layer packet (HLP) container element (e.g., as defined by the 802.11ai draft 3.0). The processor 104 may select an IP address from the IP address pool 114 and may send a set up response to the station. The set up response may identify the IP address as an assigned IP address of the station. The processor 104 may indicate (e.g., at the IP address pool 114) that the IP address has been assigned.

In a particular embodiment, the set up message is addressed to a DHCP server (e.g., the set up message includes a DHCP request). For example, the set up message may be included within a HLP message addressed to a DHCP server. In this embodiment, the access point 100 intercepts (e.g., decodes and interprets) the set up message and sends one or more responses to the station responsive to the set up message. In this example, the access point 100 decodes and interprets the HLP message and determines that the HLP message includes the set up message. In this embodiment, at least one of the one or more responses sent by the access point 100 to the station includes an IP address from the IP address pool 114. In this embodiment, the access point 100 does not send the set up message to the DHCP server. Accordingly, an association process that uses the set up message and the set up response is performed more quickly, as compared to an association process in which an access point requests an IP address from a DHCP server after receiving an IP address request from the station. For example, in an 802.11 implementation, the duration between the station transmitting the set up message and the station receiving the set up response (e.g., a latency corresponding to the set up message, to message processing, and to the set up response) in the association process that uses the set up message and the set up response is less than 0.1 seconds (e.g., 5 milliseconds). In this example, the duration may only correspond to message processing and airtime latency.

In a particular embodiment, the set up message includes a discover message that indicates that the station supports a rapid commit protocol. Thus, in a particular embodiment, the set up message indicates that the station supports a dynamic host configuration protocol (DHCP) rapid commit protocol. For example, the set up message may include a FILS HLP container element that includes a DHCP-Discover message. Thus, in a particular embodiment, the set up messages includes a DHCP discover message. In this example, the DHCP-Discover message in the FILS HLP container element may indicate that the station supports a DHCP Rapid-Commit protocol (e.g., via a flag in the DHCP-Discover message). In this particular embodiment, the access point 100 sends messages to the station in accordance with the DHCP Rapid-Commit protocol. To illustrate, the set up response may include an acknowledgement message that includes the assigned IP address. Thus, in a particular embodiment, the set up response includes a DHCP acknowledgement message indicating the assigned IP address. In this example, the set up response may include a DHCP acknowledgement (DHCP-ACK) message that includes the assigned IP address. In this example, because the set up response includes the DHCP-ACK message, a DHCP state machine at the station may be undisturbed. Thus, the station may be unaware that the DHCP-ACK message originated from the access point 100 instead of from a DHCP server.

In another particular embodiment, the set up message includes a discover message that does not indicate that the station supports a rapid commit protocol (e.g., because the station does not support the rapid commit protocol). For example, the set up message may include a FILS HLP container element that includes a DHCP-Discover message. In this example, the FILS HLP container element may not indicate that the station supports a DHCP Rapid-Commit protocol (e.g., via a flag in the DHCP-Discover message). In this particular embodiment, the access point 100 sends messages to the station in accordance with a non-rapid commit protocol. In this example, the access point 100 may send an offer response (e.g., a DHCP offer response) that includes a FILS HLP container element that includes a DHCP-Offer message. Thus, the techniques described herein support transmitting, from the access point 100, a dynamic host configuration protocol (DHCP) offer response to the station prior to assigning the available IP address to the station. In this example, the DHCP offer response identifies the available IP address. The DHCP-Offer message may offer an IP address to the station. In this example, the access point 100 may receive a request message (e.g., a DHCP request message) that includes a FILS HLP container element that includes a DHCP-Request message. Thus, the techniques described herein support receiving, at the access point 100, a DHCP request message from the station. In this example, the DHCP request message requests that the access point 100 assign the available IP address to the station. The DHCP-Request message may request that the offered IP address be assigned to the station. In this example, the access point may send the set up response in response to the request message. For example, the set up response may be sent based on receiving the DHCP request message. In this particular example, the set up response includes a DHCP acknowledgement message that includes the assigned IP address. In this example, the set up response may include a DHCP acknowledgement (DHCP-ACK) message that identifies the offered IP address as an assigned IP address. Thus, the techniques described herein support assigning, at the access point, the available IP address to the station after receiving the DHCP request message. In this example, if the access point 100 does not receive a response to the offer response, the access point 100 may indicate at the access point 100 that the offered IP address is available. In this example, because the offer response includes the DHCP-Offer message and the set up response includes the DHCP-ACK message, a DHCP state machine at the station may be undisturbed. Thus, the station may be unaware that the DHCP-Offer message and the DHCP-ACK message originated from the access point 100 instead of from a DHCP server.

In another particular embodiment, the access point 100 sends (e.g., via a FILS IP address configuration field) a configuration indicator to the station that indicates that the access point 100 can support an IP address assignment element carrying an IP address data field for request (e.g., as in the 802.11ai draft 3.0). Transmitting the configuration indicator may encourage stations to send set up messages that include IP address assignment elements carrying an IP address data field for request. In this particular embodiment, the station may be configured to determine whether to include a FILS IP address assignment carrying an IP address data field for request within the set up message in response to detecting the configuration indicator. When the station includes a FILS IP address assignment carrying an IP address data field for request within the set up message, an association process may occur more quickly, as compared to an association process corresponding to set up message that does not include a FILS IP address assignment element carrying an IP address data field for request (e.g., a FILS HLP container element that includes a DHCP-Discover message). For example, the access point 100 may process the set up message more quickly because the access point 100 may not need to perform a HLP packet inspection. Additionally, if the station sends a set up message including a FILS IP address assignment carrying an IP address data field for request to the access point 100, an association process may be performed using as few as 2 messages (e.g., the FILS IP address assignment carrying an IP address data field for request and a FILS IP address Assignment element carrying an IP Address Data Field for response (e.g., as in the 802.11ai draft 3.0)). Whereas, if the station sends a set up message including a FILS HLP container element that includes a DHCP-Discover message and the station does not indicate that the station supports a rapid commit protocol, an association process may be performed using 4 or more messages (e.g., the DHCP-Discover message, a DHCP-Offer message, a DHCP-Request message, and a DHCP-Acknowledgement (DHCP-ACK) message).

In another particular embodiment, the access point 100 sends (e.g., via a field in an association message, via a broadcast beacon, via an authentication frame, via a probe response, via a FILS discovery frame, or via another method) a caching indicator to the station that indicates that the access point 100 is storing the available IP addresses. The caching indication may be included in a FILS IP address configuration sub-field in a FILS indication element. For example, the access point 100 may broadcast a caching indicator to indicate that the access point 100 is storing the available IP addresses using reserved bits in a FILS indication element. In this particular embodiment, the station may be configured to include a FILS IP address assignment carrying an IP address data field for request within the set up message in response to detecting the caching indicator. As explained above, an association process including a set up message that includes a FILS IP address assignment carrying an IP address data field for request may occur more quickly, as compared to a FILS HLP container element that includes a DHCP-Discover message.

After the access point 100 sends the assigned IP address to the station, the access point 100 may send a gratuitous address resolution protocol (ARP) message to other devices (e.g., other access points and distribution system devices) in a subnet that includes the access point 100. Thus, the techniques described herein support transmitting, from the access point 100, a gratuitous address resolution protocol (ARP) message to a second access point after transmitting the set up response to the station. In this example, the gratuitous ARP message includes the assigned IP address. Responsive to the gratuitous ARP message, distribution system devices of the subnet may update or create routing information corresponding to the station. Further, responsive to the gratuitous ARP message, another device in the subnet may send, from the other device to the access point 100, a collision signal that indicates the other device has assigned the assigned IP address (e.g., to another station). Thus, the techniques described herein support receiving, at the access point 100, a collision signal from the second access point in response to transmitting the gratuitous ARP message. In this example, the collision signal indicates that the assigned IP address is being used by a second station associated with the second access point. In response to receiving a collision signal, the access point 100 may select a second available IP address from the IP address pool 114 and send the second available IP address to the station as the assigned IP address. Thus, the techniques described herein support selecting, at the access point 100, a second available IP address from the pool of available IP addresses to assign to the station based on the collision signal. The techniques further support assigning, at the access point 100, the second available IP address to the station as the assigned IP address. As described above, the access point 100 may send the second available IP address to the station as the assigned IP address. In a particular embodiment, the second available IP address may be identified by a second set up response. Thus, the techniques described herein support transmitting, from the access point 100, a second set up response to the station. In this example, the second set up response identifies the assigned IP address. Further, the access point 100 may send a second gratuitous ARP message that includes the second available IP address. Thus, the gratuitous ARP message may be used to update routing information corresponding to the station and may be used to detect an IP address collision.

Each available IP address of the IP address pool 114 may have a corresponding lease from the DHCP server. For example, a particular available IP address may have a lease having a duration of 3 days. After a duration corresponding to a lease passes, the DHCP server may reclaim the corresponding available IP address from the access point 100 if the access point 100 has not renewed the lease. The access point 100 may renew leases that correspond to IP addresses that are assigned to devices associated with the access point 100. The access point 100 may allow the DHCP server to reclaim leases that correspond to IP addresses that are not assigned to devices associated with the access point 100. The access point 100 may renew a lease corresponding to the assigned IP address after transmitting the set up response (e.g., including the assigned IP address) to the station. The access point 100 may periodically (e.g., before the lease expires) send a signal to the station to confirm that the station is still using the assigned IP address, and in response to a return signal from the station, the access point 100 may renew the lease.

In response to assigning a last available IP address of the IP address pool 114 (e.g., when all IP addresses at the access point 100 are indicated as being assigned), the access point 100 may send a gratuitous ARP message corresponding to each assigned IP address that does not correspond to a station associated with the access point 100. If the access point 100 does not receive a collision indicator from another device of the subnet corresponding to a particular IP address (e.g., the station assigned the particular IP address has left the subnet), the access point 100 may indicate that the particular IP address is not assigned. If the access point 100 receives a collision indicator from another device of the subnet corresponding to the particular IP address (e.g., the station assigned the particular IP address has not left the subnet), the access point 100 may indicate, at the access point 100, that the particular IP address is assigned.

Although the processor 104 is described as executing based on the instructions 118, the processor 104 may perform one or more actions described herein based on other instructions stored at the memory 102, stored at the processor 104, or stored at another location. Although the memory 102 is described as including the private MAC addresses 112, the IP address pool 114, the BSSID 116, and the instructions 118, one or more of the private MAC addresses 112, the IP address pool 114, the BSSID 116, and the instructions 118 may be stored at the processor 104 (e.g., one or more registers of the processor 104) or at another location. Although the DHCP server is described as being separate from the access point 100, in a particular embodiment, the access point 100 is co-located with the DHCP server. For example, the access point 100 may include separate, dedicated components corresponding to the DHCP server, or the DHCP server may operate using components of the access point 100 described herein, or a combination thereof).

By using the IP address pool 114, the access point 100 may assign an IP address to a station more quickly, as compared to an access point that requests an IP address from a DHCP server, in response to receiving an IP address request from the station. Thus, the access point 100 and the station may complete an association process more quickly, as compared to a station associating with an access point of another IP address assignment system.

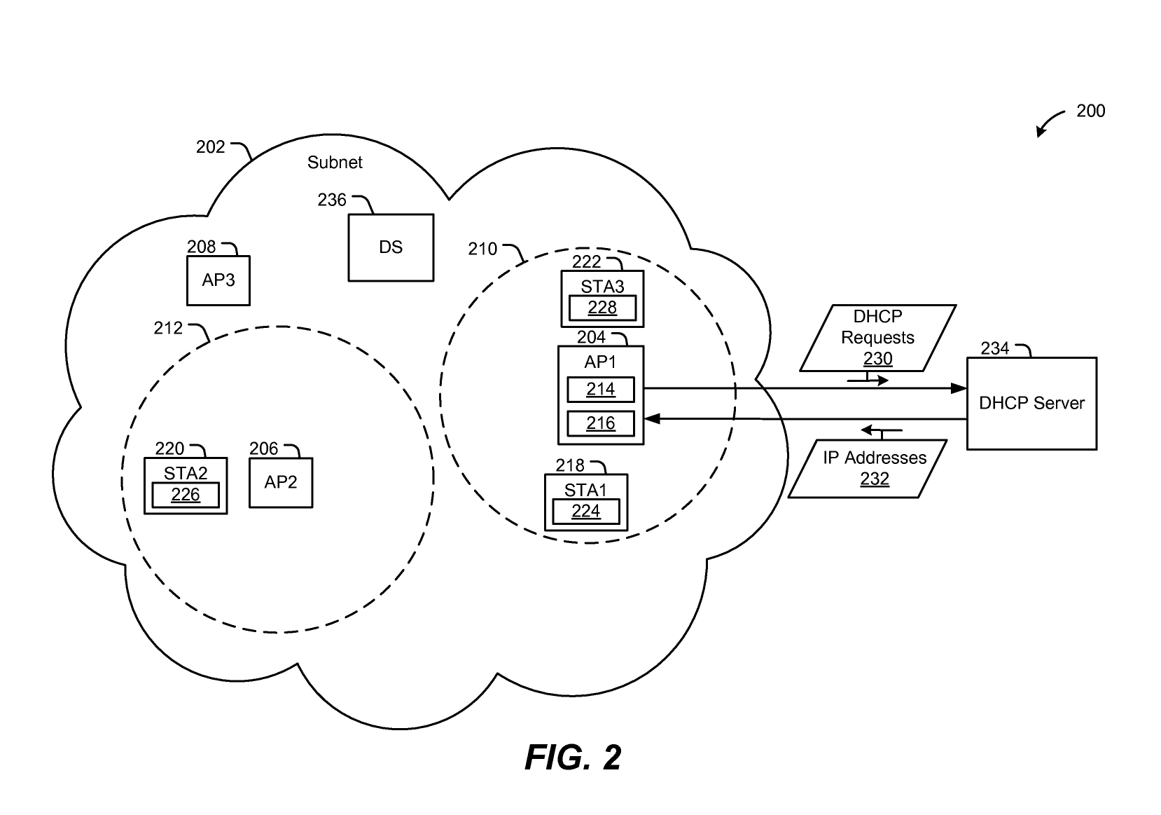

Referring to FIG. 2, a particular illustrative embodiment of an internet protocol (IP) address assignment system is disclosed and generally designated 200. The IP address assignment system 200 includes a subnet 202 and a dynamic host configuration protocol (DHCP) server 234. The subnet 202 may include one or more access points (e.g., a first access point 204, a second access point 206, and a third access point 208), a distribution system (DS) 236, and one or more stations (e.g., a first station 218, a second station 220, and a third station 222).

The DS 236 may include routing information corresponding to stations (e.g., the first station 218, the second station 220, and the third station 222) of the subnet 202. The DS 236 may send a message received at the subnet 202 and addressed to a particular station (e.g., to the first station 218) to an access point (e.g., to the first access point 204) associated with the particular station. The DS 236 may be part of an access point or may be a separate device. Each access point may have a corresponding broadcast area (e.g., the first access point 204 has a first broadcast area 210 and the second access point 206 has a second broadcast area 212). Each access point may include a list of private media access control (MAC) addresses (e.g., a representative list of private MAC addresses 214) and a pool of available IP addresses (e.g., a representative pool of available IP addresses 216). Alternatively, the second access point 206, the third access point 208, or both, may not include a list of private MAC addresses and may not include a pool of available IP addresses. Although the DHCP server 234 is illustrated as being outside the subnet 202, in other embodiments, the DHCP server 234 may be a separate device within the subnet 202 or may be co-located with or included within a device of the subnet 202 (e.g., within the DS 236 or within the first access point 204). In a particular embodiment, at least one access point (e.g., the first access point 204) of the subnet 202 corresponds to the access point 100 described with reference to FIG. 1.

At an access point, a list of private MAC addresses (e.g., valid MAC address stored at the access point that are distinct from a MAC address used by the access point to communicate with a DHCP server) may be used to populate a pool of available IP addresses. For example, at the first access point 204, the list of private MAC addresses 214 may be used to populate the pool of available IP addresses 216. In this example, the first access point 204 may send (e.g., directly, via another access point, via the DS 236, or via another device) multiple DHCP requests 230 to the DHCP server 234. Each DHCP request of the multiple DHCP requests 230 may correspond to a private MAC address of the list of private MAC addresses 214. Thus, the techniques described herein support transmitting, from the access point, multiple dynamic host configuration protocol (DHCP) requests to a DHCP server. In this example, each DHCP request includes a corresponding private media access control (MAC) address. The DHCP server 234 may send an IP address of multiple IP addresses 232 to the first access point 204 responsive to each DHCP request of the multiple DHCP requests 230. Thus, the techniques described herein support receiving, at the access point, multiple IP addresses from the DHCP server. In this example, each IP address corresponds to a DHCP request of the multiple DHCP requests. The first access point 204 may store each IP address of the multiple IP addresses 232 at the pool of available IP addresses 216 and may assign each IP address of the multiple IP addresses 232 to the pool of available IP addresses 216. Thus, the techniques described herein support assigning, at the access point, the multiple IP addresses to the pool of available IP addresses.

An association process between an access point and a station within a broadcast area of the access point may include the station transmitting a set up message that includes an IP address request. For example, as part of an association process between the first access point 204 and the first station 218, the first station 218 may send a set up message (e.g., a fast initial link setup (FILS) higher layer packet (HLP) container element or a FILS IP address assignment element carrying an IP address data field for request) that requests allocation of an IP address to the first station 218. The set up message may be addressed to the DHCP server 234 (e.g., the set up message may include a DHCP request). The access point may select an available IP address from the IP address pool of the access point and may send a set up response to the station that identifies the selected IP address as an assigned IP address of the station. In this example, the first access point 204 may select an IP address from the pool of available IP addresses 216 and may send a set up response to the first station 218 that identifies the selected IP address as the assigned IP address of the first station 218. The station may store the assigned IP address and may use the assigned IP address when communicating with other devices. In this example, the first station 218 may store the assigned IP address at a memory location 224 of the first station 218. Each station associated with an access point (e.g., the first access point 204, the second access point 206, or the third access point 208) of a subnet (e.g., the subnet 202) may store a different assigned IP address. For example, the first station 218 may store the assigned IP address at the memory location 224, the second station 220 may store a second assigned IP address at a memory location 226 of the second station 220, and the third station 222 may store a third assigned IP address at a memory location 228 of the third station 222.

After transmitting a set up response, an access point may send a gratuitous address resolution protocol (ARP) message to other devices (e.g., other access points and distribution system devices) of a subnet that includes the access point. The gratuitous ARP message includes the assigned IP address. For example, after the first access point 204 sends the set up response that identifies the available IP address from the pool of available IP addresses 216 as the assigned IP address of the first station 218, the first access point 204 may transmit a gratuitous ARP message to other devices (e.g., the second access point 206, the third access point 208, and the DS 236) of the subnet 202. Responsive to the gratuitous ARP message, distribution system devices (e.g., the DS 236) of the subnet may update or create routing information corresponding to the station. Thus, in this example, a distribution system (DS) updates routing information corresponding to the station based on the gratuitous ARP message. Further, responsive to the gratuitous ARP message, another device in the subnet may send, from the other device to the access point 100, a collision signal that indicates that the other device has assigned the assigned IP address (e.g., to another station).

In response to receiving a collision signal, an access point may select a second IP address from a corresponding pool of available IP addresses and send the second IP address to the station as the assigned address. In this example, the first access point 204 may select a second IP address from the pool of available IP addresses 216 and send the second IP address to the first station 218 in a second set up response that identifies the second IP address as the assigned IP address of the first station 218. The first station 218 may store the assigned address (e.g., corresponding to the second IP address) at the memory location 224. The access point may send a second gratuitous ARP message that includes the assigned IP address. Thus, the gratuitous ARP message may be used to update routing information corresponding to the station and may be used to detect an IP address collision.

Each IP address of each pool of available IP addresses (e.g., the pool of available IP addresses 216) and each assigned IP address (e.g., the assigned IP address stored at the memory location 224, the assigned IP address stored at the memory location 226, and the assigned IP address stored at the memory location 228) may have a corresponding lease from the DHCP server 234. For example, a particular IP address may have a lease having a duration of 12 hours. After a duration corresponding to a lease passes, the DHCP server 234 may reclaim the corresponding IP address if the corresponding access point has not renewed the lease. The access point may renew a lease corresponding to an assigned IP address after transmitting a set up response to a station. For example, the first access point 204 may renew a lease corresponding to an assigned IP address assigned to the first station 218 after transmitting a set up response that identifies the assigned IP address as the assigned IP address of the first station 218. In a particular embodiment, the access point renews the lease by transmitting a renewal request to the DHCP server 234. The access point may periodically (e.g., before the lease expires) send a signal to the station to confirm that the station is still using the assigned IP address, and in response to a return signal from the station, the access point may renew the lease. The access point may also renew all or some of a corresponding pool of available IP addresses that are not assigned to stations. Alternatively, the access point may allow leases to expire for some or all of the available IP addresses of the corresponding pool of available IP addresses.

In a particular embodiment, the set up message between the first station 218 and the first access point 204 is addressed to the DHCP server 234 (e.g., the set up message includes a DHCP request). In this embodiment, the first access point 204 intercepts (e.g., decodes and interprets) the set up message and sends one or more responses to the first station 218 responsive to the set up message. The first access point 204 may not send the set up message to the DHCP server 234. In this embodiment, at least one of the one or more responses sent by the first access point 204 to the first station 218 includes an IP address from the pool of available IP addresses 216. By using an IP address from the pool of available IP addresses 216, an association process that uses the set up message and the set up response is performed more quickly, as compared to an access point that requests an IP address from a DHCP server in response to receiving an IP address request from the station. For example, a duration between the first station 218 transmitting the set up message and the first station 218 receiving the set up response (e.g., a latency corresponding to the set up message and to the set up response) in the association process that uses the set up message and the set up response is less than 0.1 seconds (e.g., 5 milliseconds).

An access point (e.g., the first access point 204) of the IP address assignment system 200 may assign an IP address to a station (e.g., the first station 218) more quickly, as compared to an access point that requests an IP address from a DHCP server, in response to receiving an IP address request from the station. Thus, the access point and the station may complete an association process more quickly, as compared to a station associating with an access point of another IP address assignment system.

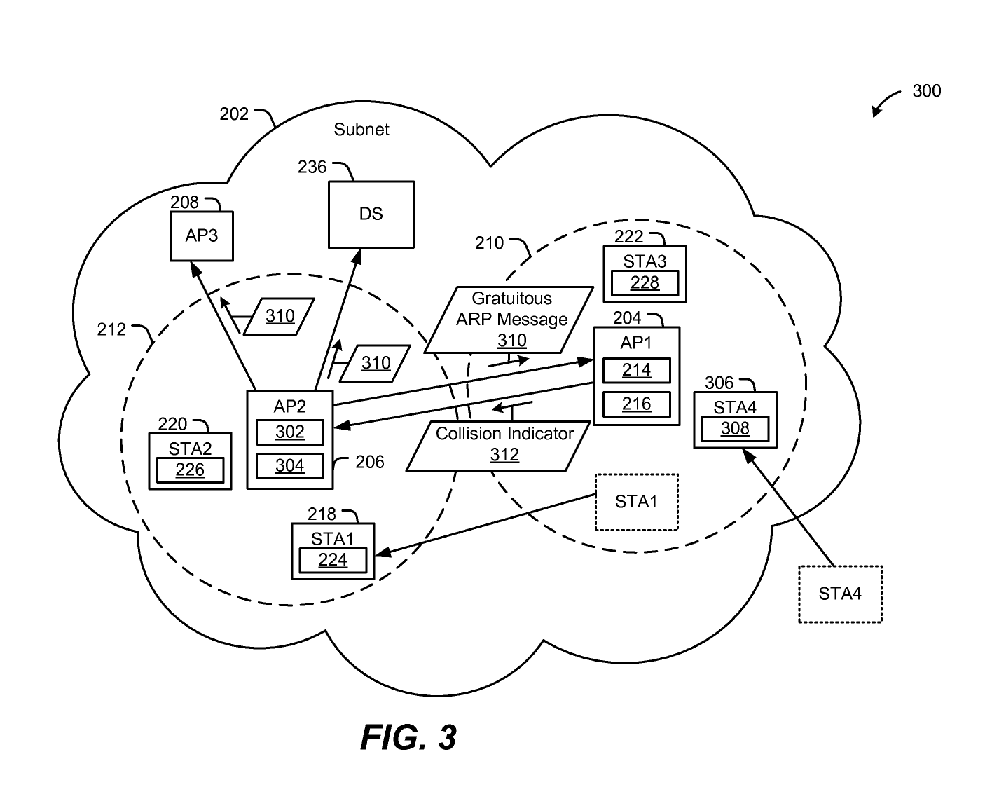

Referring to FIG. 3, a particular illustrative embodiment of an internet protocol (IP) address assignment system is disclosed and generally designated 300. The IP address assignment system 300 includes the IP address assignment system 200 of FIG. 2 and illustrates a roaming scenario. The IP address assignment system 300 includes a fourth station 306.

As described with reference to FIG. 2, the first station 218 may associate with the first access point 204 and may receive an assigned IP address from the pool of available IP addresses 216. The assigned IP address may be stored at the memory location 224. Subsequently, the first station 218 may leave the first broadcast area 210. For example, the first station 218 may be moved by a user. When the first station 218 enters a broadcast area of an access point of the subnet 202, the first station 218 may send an IP-specifying set up request message to the access point. For example, when the first station 218 enters the second broadcast area 212, the first station 218 may send an IP-specifying set up request message to the second access point 206. The IP-specifying set up message may request that the IP address stored at the memory location 224 (e.g., an assigned IP address received from the first access point 204) be allocated to the first station 218 by the second access point 206. A portion of the requested IP address may identify the subnet 202 (e.g., the requested IP address corresponds to an assigned IP address of the subnet 202).

The access point may select an IP address and send the IP address to the first station 218. In this example, the second access point 206 may receive the requested IP address and may determine whether the requested IP address corresponds to an IP address at a pool of available IP addresses 304 (e.g., available IP addresses generated, as described with reference to FIGS. 1 and 2, using a list of private media access control (MAC) addresses 302) at the second access point 206. If the requested IP address corresponds to an available IP address at the second access point 206 the second access point 206 may send a set up response that identifies the requested IP address as the assigned IP address of the first station 218. If the requested IP address is indicated at the second access point 206 as being assigned, then the second access point 206 may send a set up response that identifies another IP address of the pool of available IP addresses 304 as the assigned IP address of the first station 218.

If the requested IP address does not correspond to an available IP address at the second access point 206 and the requested IP address is not indicated at the second access point 206 as being assigned, the second access point 206 may send a gratuitous address resolution protocol (ARP) message 310 to other devices (e.g., other access points and distribution system devices) of the subnet 202. The gratuitous ARP message 310 includes the requested IP address. If an access point (e.g., the third access point 208) of the subnet 202 is not associated with a station that has been assigned the requested IP address, the access point may not send a response to the gratuitous ARP message 310 to the second access point 206. Alternatively, the access point may send a response to the gratuitous ARP message 310 indicating that the access point is not associated with a station that has been assigned the requested IP address. If the access point (e.g., the third access point 208) is associated with a station that has been assigned the requested IP address, the access point may send a collision indicator to the second access point 206. Thus, the techniques described herein support transmitting, from the access point, a collision indicator to a second access point based on receiving a gratuitous address resolution protocol (ARP) message that includes the assigned IP address. If the second access point 206 does not receive a collision indicator, responsive to the gratuitous ARP message 310, that indicates that the IP address is being used by another station of the subnet 202, the second access point 206 may send a set up response to the first station 218 that identifies the requested IP address as the assigned IP address of the first station 218.

If the second access point 206 receives a collision indicator (e.g., a collision indicator 312) from another device in the subnet 202, the second access point 206 may send a set up response to the first station 218 that identifies another IP address of the pool of available IP addresses 304 as the assigned IP address of the first station 218. In a particular embodiment, after the first station 218 has left the first broadcast area 210 but before the second access point 206 sends the gratuitous ARP message 310, the first access point 204 may reassign the requested IP address to another station (e.g., the requested IP address may be stored at a memory location 308 of the fourth station 306). Thus, in response to receiving the gratuitous ARP message 310, the first access point 204 may determine that the requested IP address is assigned to the fourth station 306. In the particular embodiment, the first access point 204 may send the collision indicator 312 to the second access point 206. In response to receiving the collision indicator 312, the second access point 206 sends a set up response to the first station 218 that identifies another IP address of the pool of available IP addresses 304 as the assigned IP address of the first station 218.

As described with reference to FIGS. 1 and 2, after transmitting the set up response, the second access point 206 may send a lease renewal request (e.g., an IP lease renewal request) that includes the assigned IP address. In a particular example, the lease renewal request may be sent at a time when the assigned IP address is about to expire. If the assigned IP address corresponds to an IP address of the pool of available IP addresses 304, the second access point 206 may also send a gratuitous ARP message that includes the assigned IP address. Thus, the techniques described herein support transmitting, from the access point, an IP lease renewal request to the DHCP server after transmitting the set up response to the station at a time when the assigned IP address is about to expire. In this example, the IP lease renewal request corresponds to the assigned IP address.

Using the process described with respect to FIG. 3, an access point (e.g., the second access point 206) of the IP address assignment system 300 may allow a station (e.g., the first station 218) to keep an IP address while roaming between access points of the subnet 202. When a station is allowed to keep an IP address while roaming, additional available IP addresses may be assigned more efficiently, as compared to a system wherein stations are assigned a new available IP address in response to each set up message.

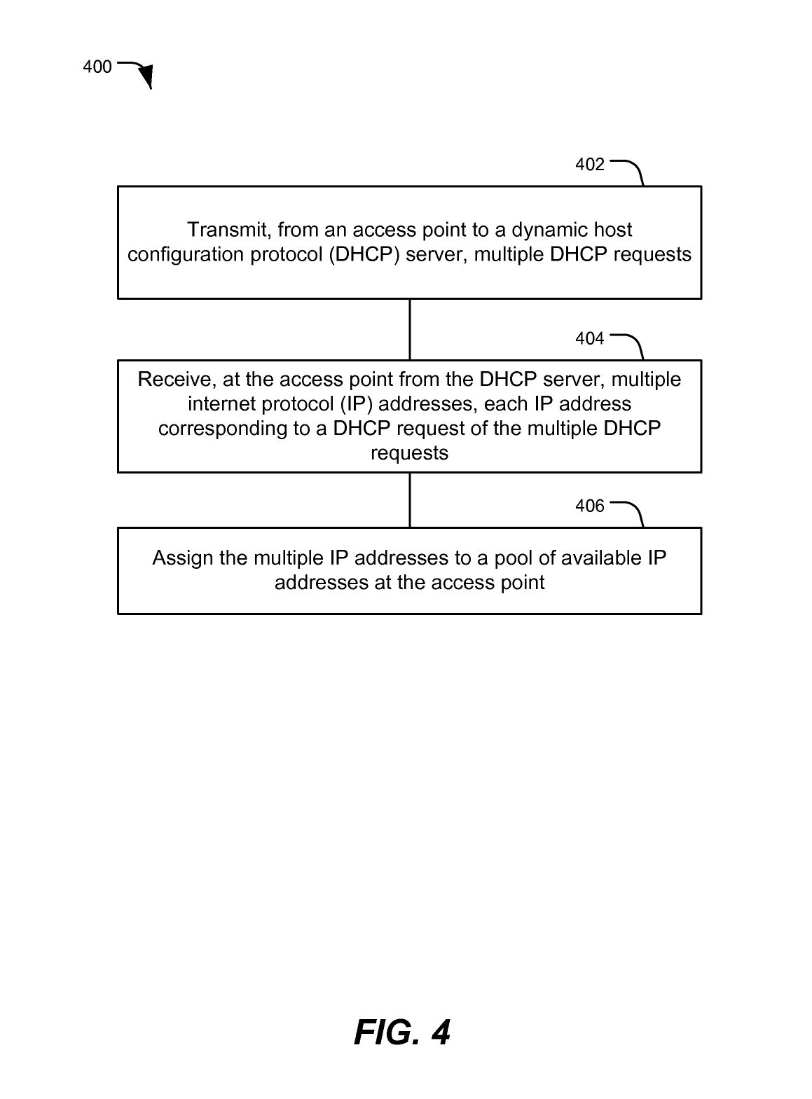

FIG. 4 is a flowchart illustrating a method 400 of configuring an internet protocol (IP) address assignment system. The method 400 includes, at 402, transmitting, from an access point to a dynamic host configuration protocol (DHCP) server, multiple DHCP requests, each DHCP request including a corresponding private media access control (MAC) address. For example, the first access point 204 of FIG. 2 may send multiple DHCP requests 230 to the DHCP server 234, each DHCP request of the multiple DHCP requests 230 including a corresponding private MAC address from the list of private MAC addresses 214.

The method 400 also includes, at 404, receiving at the access point from the DHCP server, multiple IP addresses, each IP address corresponding to a DHCP request of the multiple DHCP requests. For example, the first access point 204 of FIG. 2 may receive, from the DHCP server 234, the multiple IP addresses 232, each IP address of the multiple IP addresses 232 corresponding to a DHCP request of the multiple DHCP requests 230. The method 400 also includes, at 406, assigning the multiple IP addresses to a pool of available IP addresses at the access point. For example, the first access point 204 of FIG. 2 may assign the multiple IP addresses 232 to the pool of available IP addresses 216. As described with reference to FIGS. 1 and 2, when an access point stores multiple IP addresses to a pool of available IP addresses, the access point may enable a station to complete an authentication process more quickly, as compared to an authentication process where the access point contacts a DHCP server to request an IP address in response to receiving a set up message from a station.

The method 400 of FIG. 4 may be initiated and/or performed by a processing unit such as a central processing unit (CPU), a field-programmable gate array (FPGA) device, an application-specific integrated circuit (ASIC), a controller, another hardware device, firmware device, or any combination thereof. As an example, the method 400 of FIG. 4 can be performed by one or more processors or execution units that execute instructions, as further described with reference to FIG. 1.

An access point operating according to the method 400 may assign an IP address to a station more quickly, as compared to an access point that requests an IP address from a DHCP server in response to receiving an IP address request from the station. Thus, the access point and the station may complete an association process more quickly, as compared to a station associating with an access point of another IP address assignment system.

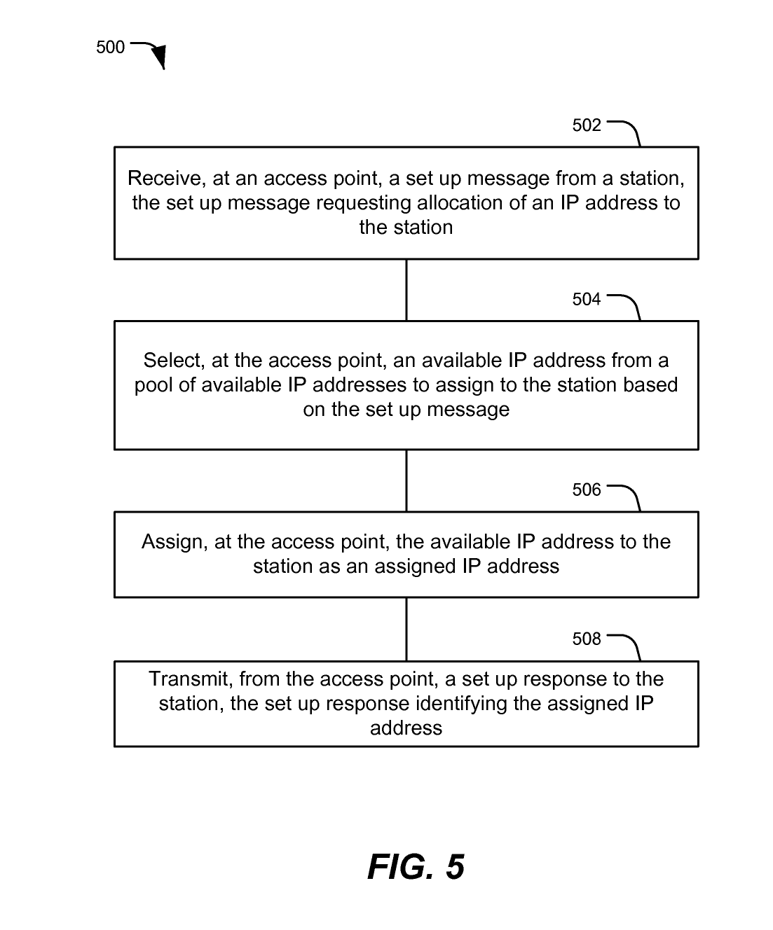

FIG. 5 is a flowchart illustrating a method 500 of configuring an internet protocol (IP) address assignment system. The method 500 includes, at 502, receiving, at an access point from a station, a set up message, the set up message requesting allocation of an IP address to the station. For example, the first access point 204 of FIG. 2 may receive, from the first station 218, a set up message that requests allocation of an IP address to the first station 218.

The method 500 also includes, at 504, selecting an available IP address from a pool of available IP addresses to assign to the station based on the set up message, each IP address of the pool of available IP addresses corresponding to a private media access control (MAC) address. For example, the first access point 204 of FIG. 2 may select an IP address from the pool of available IP addresses 216. Each IP address of the pool of available IP addresses 216 may correspond to a private MAC address of the list of private MAC addresses 214. The method 500 also includes, at 506, assigning the available IP address to the station as an assigned IP address. For example, the first access point 204 of FIG. 2 may assign the selected IP address to the first station 218. The method 500 also includes, at 508, transmitting, from the access point to the station, a set up response that identifies the assigned IP address. For example, the first access point 204 of FIG. 2 may send, to the first station 218, a set up response that identifies the IP address from the pool of available IP addresses 216 as an assigned IP address of the first station 218. As described with reference to FIGS. 1 and 2, when an access point assigns IP addresses to stations from a pool of available IP addresses at the access point, the access point may enable a station to complete an association process more quickly, as compared to an association process where the access point contacts a DHCP server to request an IP address in response to receiving a set up message from a station.

The method 500 of FIG. 5 may be initiated and/or performed by a processing unit such as a central processing unit (CPU), a field-programmable gate array (FPGA) device, an application-specific integrated circuit (ASIC), a controller, another hardware device, firmware device, or any combination thereof. As an example, the method 500 of FIG. 5 can be performed by one or more processors or execution units that execute instructions, as further described with reference to FIG. 1.

An access point operating according to the method 500 may assign an IP address to a station more quickly, as compared to an access point that requests an IP address from a DHCP server in response to receiving an IP address request from the station. Thus, the access point and the station may complete an association process more quickly, as compared to a station associating with an access point of another IP address assignment system.

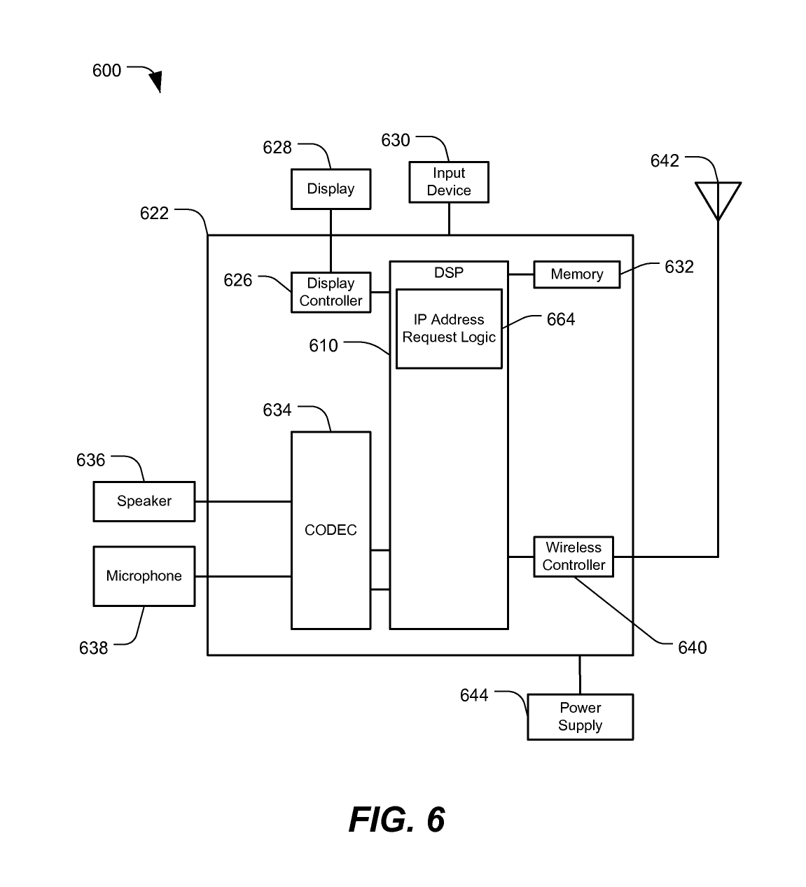

Referring to FIG. 6, a block diagram depicts a particular illustrative embodiment of a mobile device 600 that includes internet protocol (IP) address request logic 664. The mobile device 600, or components thereof, may include, implement, or be included within a device such as a communications device, a mobile phone, a cellular phone, a computer, a portable computer, a tablet, an entertainment unit, a navigation device, a personal digital assistant (PDA), a mobile location data unit, a monitor, a computer monitor, a television, a tuner, a radio, a satellite radio, a music player, a digital music player, a portable music player, a video player, a digital video player, a digital video disc (DVD) player, or a portable digital video player. The mobile device 600 may correspond to the first station 218 of FIGS. 2 and 3, to the second station 220 of FIGS. 2 and 3, to the third station 222 of FIGS. 2 and 3, or to the fourth station 306 of FIG. 3.

The mobile device 600 may include a processor 610, such as a digital signal processor (DSP). The processor 610 may include the IP address request logic 664 or may be distinct from the IP address request logic 664. The IP address request logic 664 may be used as part of an association process with an access point, as described with reference to FIGS. 1-3 and 5. The IP address request logic 664 may be configured to detect that the access point is caching IP addresses (e.g., via a caching indicator transmitted by the access point). The IP address logic 664 may cause the mobile device 600 to send an IP address request packet directed to the access point (e.g., instead of an IP address packet directed to a dynamic host configuration protocol (DHCP) server), as described above with reference to FIG. 1. For example, the IP address request logic 664 may cause the mobile device 600 to send a set up message including an IP address request using a fast initial link setup (FILS) higher layer packet (HLP) container element. In response to detecting the caching indicator, the IP address request logic 664 may cause the mobile device 600 to send a set up message that includes an IP address request using a FILS IP address assignment element carrying an IP address data field for request. Thus, the techniques described herein support transmitting, from the access point, a caching indicator to the station. In this example, the set up message is responsive to the caching indicator, and the set up message includes a fast initial link setup (FILS) IP address request element (e.g., the IP address request). In a particular embodiment, the caching indicator is transmitted by the access point as part of a beacon, part of a probe response, or part of a fast initial link setup (FILS) discovery frame. In one aspect of the techniques described herein, the caching indicator is included in a fast initial link setup (FILS) IP address configuration sub-field in a FILS indication element.

One or more higher layer packets (HLPs) may be received and inspected at the access point to detect the set up message. For example, the access point may inspect (e.g., decode) one or more HLPs to detect a set up message from the station. To illustrate, the access point may decode one or more HLPs to determine whether an allocation request of an IP address to the station is included in the one or more HLPs. Thus, the techniques described herein support receiving, at the access point, one or more higher layer packets (HLPs). The techniques further support inspecting, at the access point, the one or more HLPs to detect the set up message. Alternatively, an association process including a set up message that includes a FILS IP address assignment element carrying an IP address data field for request may occur more quickly, as compared to a FILS HLP container element (e.g., the one or more HLPs). For example, the access point may process the set up message more quickly because the access point may not need to perform a HLP packet inspection. As another example, the access point may process the set up message more quickly because a handshake protocol based on an IP request using a FILS address assignment carrying an IP address data field for request may be performed using the same number of steps as a rapid commit protocol, even if the mobile device 600 does not support a rapid commit protocol. To illustrate, if the mobile device 600 sends a set up message including a FILS IP address assignment carrying an IP address data field for request to the access point, an association process may be performed using as few as 2 messages (e.g., the FILS IP address assignment carrying an IP address data field for request and a FILS IP address Assignment element carrying an IP Address Data Field for response). Whereas, if the mobile device 600 sends a set up message including a FILS HLP container element that includes a DHCP-Discover message and the mobile device 600 does not indicate that the mobile device 600 supports a rapid commit protocol, an association process may be performed using 4 or more messages (e.g., the DHCP-Discover message, a DHCP-Offer message, a DHCP-Request message, and a DHCP-Acknowledgement (DHCP-ACK) message). The processor 610 may be coupled to a memory 632 (e.g., a non-transitory computer-readable medium).

FIG. 6 also shows a display controller 626 that is coupled to the processor 610 and to a display 628. A coder/decoder (CODEC) 634 can also be coupled to the processor 610. A speaker 636 and a microphone 638 can be coupled to the CODEC 634. A wireless controller 640 can be coupled to the processor 610 and can be further coupled to an antenna 642.

In a particular embodiment, the processor 610, the display controller 626, the memory 632, the CODEC 634, the wireless controller 640, and the IP address request logic 664 are included in a system-in-package or system-on-chip device 622. An input device 630 and a power supply 644 may be coupled to the system-on-chip device 622. Moreover, in a particular embodiment, and as illustrated in FIG. 6, the display 628, the input device 630, the speaker 636, the microphone 638, the antenna 642, and the power supply 644 are external to the system-on-chip device 622. However, each of the display 628, the input device 630, the speaker 636, the microphone 638, the antenna 642, and the power supply 644 can be coupled to a component of the system-on-chip device 622, such as an interface or a controller. The IP address request logic 664 may be included in the system-on-chip device 622, as shown in FIG. 6, or may be included in one or more separate components.

In conjunction with the described embodiments, an apparatus (such as the access point 100 of FIG. 1, the first access point 204, the second access point 206, or the third access point 208 of FIG. 2 or FIG. 3) may include means for transmitting (e.g., the network controller 106 and the antenna 110 or the network controller 106 and the network interface 108 of FIG. 1), from an access point to a dynamic host configuration protocol (DHCP) server (e.g., the DHCP server 234 of FIG. 2), multiple DHCP requests, each DHCP request including a corresponding private media access control (MAC) address (e.g., the private MAC addresses of the list of private MAC addresses 112 of FIG. 1, the private MAC addresses of the list of private MAC addresses 214 of FIGS. 2 and 3, or the private MAC addresses of the list of private MAC addresses 302 of FIG. 3). The apparatus may further include means for receiving (e.g., the network controller 106 and the antenna 110 or the network controller 106 and the network interface 108 of FIG. 1), at the access point from the DHCP server, multiple internet protocol (IP) addresses, each IP address of the multiple IP addresses corresponding to a DHCP request of the multiple DHCP requests. The apparatus may further include means for assigning (e.g., the processor 104 of FIG. 1) the multiple IP addresses to a pool of available IP addresses (e.g., the IP address pool 114 of FIG. 1, the pool of available IP addresses 216 of FIGS. 2 and 3, or the pool of available IP addresses 304 of FIG. 3) at the access point.

Alternatively, in conjunction with the described embodiments, an apparatus (such as the access point 100 of FIG. 1, the first access point 204, the second access point 206, or the third access point 208 of FIG. 2 or FIG. 3) may include means for receiving (e.g., the network controller 106 and the antenna 110 or the network controller 106 and the network interface 108 of FIG. 1), at an access point from a station (e.g., the first station 218, the second station 220, or the third station 222 of FIGS. 2 and 3, the fourth station 306 of FIG. 3, or the mobile device 600 of FIG. 6), a set up message, the set up message requesting allocation of an internet protocol (IP) address to the station. The apparatus may further include means for selecting (e.g., the processor 104 of FIG. 1) an available IP address from a pool of available IP addresses (e.g., the IP address pool 114 of FIG. 1, the pool of available IP addresses 216 of FIGS. 2 and 3, or the pool of available IP addresses 304 of FIG. 3) at the access point, each IP address of the pool of available IP addresses corresponding to a private media access control (MAC) address (e.g., the private MAC addresses of the list of private MAC addresses 112 of FIG. 1, the private MAC addresses of the list of private MAC addresses 214 of FIGS. 2 and 3, or the private MAC addresses of the list of private MAC addresses 302 of FIG. 3). The apparatus may further include means for sending (e.g., the network controller 106 and the antenna 110 or the network controller 106 and the network interface 108 of FIG. 1), from the access point to the station, a set up response that identifies the available IP address as an assigned IP address of the station.

In conjunction with the described embodiments, a non-transitory computer-readable medium stores instructions that, when executed by a processor, cause the processor to initiate transmitting, from an access point to a dynamic host configuration protocol (DHCP) server, multiple DHCP requests, each DHCP request including a corresponding private media access control (MAC) address. The non-transitory computer readable medium may further include instructions that, when executed by the processor, cause the processor to initiate receiving, at the access point from the DHCP server, multiple internet protocol (IP) addresses, each IP address of the multiple IP addresses corresponding to a DHCP request of the multiple DHCP requests. The non-transitory computer readable medium may further include instructions that, when executed by the processor, cause the processor to assign the multiple IP addresses to a pool of available IP addresses at the access point.

The non-transitory computer-readable medium may correspond to the memory 102 of FIG. 1. The instructions may correspond to the instructions 118 of FIG. 1. The processor may correspond to the processor 104 of FIG. 1. The access point may correspond to the access point 100 of FIG. 1, or to the first access point 204, the second access point 206, or the third access point of FIGS. 2 and 3. The DHCP server may correspond to the DHCP server 234 of FIG. 2. The pool of available IP addresses may correspond to the IP address pool 114 of FIG. 1, the pool of available IP addresses 216 of FIGS. 2 and 3, or the pool of available IP addresses 304 of FIG. 3.

Alternatively, in conjunction with the described embodiments, a non-transitory computer readable medium includes instructions that, when executed by a processor, cause the processor to initiate receiving, at an access point from a station, a set up message, the set up message requesting allocation of an internet protocol (IP) address to the station. The non-transitory computer readable medium may further include instructions that, when executed by the processor, cause the processor to select an available IP address from a pool of available IP addresses at the access point, each IP address of the pool of available IP addresses corresponding to a private media access control (MAC) address. The non-transitory computer readable medium may further include instructions that, when executed by the processor, cause the processor to initiate transmitting, from the access point to the station, a set up response that identifies the available IP address as an assigned IP address of the station.

The non-transitory computer-readable medium may correspond to the memory 102 of FIG. 1. The instructions may correspond to the instructions 118 of FIG. 1. The processor may correspond to the processor 104 of FIG. 1. The access point may correspond to the access point 100 of FIG. 1, or to the first access point 204, the second access point 206, or the third access point of FIGS. 2 and 3. The station may correspond to the first station 218, the second station 220, or the third station 222 of FIGS. 2 and 3, the fourth station 306 of FIG. 3, or the mobile device 600 of FIG. 6. The pool of available IP addresses may correspond to the IP address pool 114 of FIG. 1, the pool of available IP addresses 216 of FIGS. 2 and 3, or the pool of available IP addresses 304 of FIG. 3.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method for fast internet protocol (IP) address assignment in a wireless communication network, the method comprising:
receiving, at an access point, a set up message from a station, the set up message requesting allocation of an IP address to the station;
selecting, at the access point, an available IP address from a pool of available IP addresses to assign to the station based on the set up message;
assigning, at the access point, the available IP address to the station as an assigned IP address; and
transmitting, from the access point, a set up response to the station, the set up response identifying the assigned IP address.

2. The method of claim 1, wherein the set up message indicates that the station supports a dynamic host configuration protocol (DHCP) rapid commit protocol.

3. The method of claim 2, wherein the set up message includes a DHCP discover message, and wherein the set up response includes a DHCP acknowledgement message indicating the assigned IP address.

4. The method of claim 1, further comprising:
transmitting, from the access point, a dynamic host configuration protocol (DHCP) offer response to the station prior to assigning the available IP address to the station, the DHCP offer response identifying the available IP address;
receiving, at the access point, a DHCP request message from the station, the DHCP request message requesting that the access point assign the available IP address to the station; and
assigning, at the access point, the available IP address to the station after receiving the DHCP request message.

5. The method of claim 4, wherein the set up response is sent based on receiving the DHCP request message, the set up response including a DHCP acknowledgement message that includes the assigned IP address.

6. The method of claim 1, further comprising transmitting, from the access point, a gratuitous address resolution protocol (ARP) message to a second access point after transmitting the set up response to the station, the gratuitous ARP message including the assigned IP address.

7. The method of claim 6, further comprising receiving, at the access point, a collision signal from the second access point in response to transmitting the gratuitous ARP message, the collision signal indicating that the assigned IP address is being used by a second station associated with the second access point.

8. The method of claim 7, further comprising:
selecting, at the access point, a second available IP address from the pool of available IP addresses to assign to the station based on the collision signal;
assigning, at the access point, the second available IP address to the station as the assigned IP address; and
transmitting, from the access point, a second set up response to the station, the second set up response identifying the assigned IP address.

9. The method of claim 6, wherein a distribution system (DS) updates routing information corresponding to the station based on the gratuitous ARP message.

10. The method of claim 1, further comprising transmitting, from the access point, a collision indicator to a second access point based on receiving a gratuitous address resolution protocol (ARP) message that includes the assigned IP address.

11. The method of claim 1, further comprising transmitting, from the access point, a caching indicator to the station.

12. The method of claim 11, wherein the set up message is responsive to the caching indicator, and wherein the set up message includes a fast initial link setup (FILS) IP address request element.

13. The method of claim 11, wherein the caching indicator is transmitted by the access point as part of a beacon, part of a probe response, or part of a fast initial link setup (FILS) discovery frame.

14. The method of claim 11, wherein the caching indicator is included in a fast initial link setup (FILS) IP address configuration sub-field in a FILS indication element.

15. The method of claim 1, further comprising:
receiving, at the access point, one or more higher layer packets (HLPs); and
inspecting, at the access point, the one or more HLPs to detect the set up message.

16. The method of claim 1, further comprising:
transmitting, from the access point, multiple dynamic host configuration protocol (DHCP) requests to a DHCP server, each DHCP request including a corresponding private media access control (MAC) address;
receiving, at the access point, multiple IP addresses from the DHCP server, each IP address corresponding to a DHCP request of the multiple DHCP requests; and
assigning, at the access point, the multiple IP addresses to the pool of available IP addresses.

17. The method of claim 16, further comprising transmitting, from the access point, an IP lease renewal request to the DHCP server after transmitting the set up response to the station at a time when the assigned IP address is about to expire, the IP lease renewal request corresponding to the assigned IP address.

18. The method of claim 16, wherein the access point is co-located with the DHCP server.

19. The method of claim 16, further comprising generating, at the access point, at least one private MAC address using a basic service set identification (BSSID) of the access point.

20. The method of claim 16, wherein at least one private MAC address is assigned to the access point by a vendor.

21. An apparatus comprising:
a processor; and
a memory storing instructions executable by the processor to perform operations comprising:
receiving, at an access point, a set up message from a station, the set up message requesting allocation of an internet protocol (IP) address to the station;
selecting, at the access point, an available IP address from a pool of available IP addresses to assign to the station based on the set up message;
assigning, at the access point, the available IP address to the station as an assigned IP address; and
transmitting, from the access point, a set up response to the station, the set up response identifying the assigned IP address.

22. The apparatus of claim 21, wherein the pool of available IP addresses corresponds to a portion of the memory.

23. The apparatus of claim 21, wherein the operations further comprise:
transmitting, from the access point, multiple dynamic host configuration protocol (DHCP) requests to a DHCP server, each DHCP request including a corresponding private media access control (MAC) address;
receiving, at the access point, multiple IP addresses from the DHCP server, each IP address corresponding to a DHCP request of the multiple DHCP requests; and
assigning, at the access point, the multiple IP addresses to the pool of available IP addresses.

24. The apparatus of claim 21, wherein the set up message indicates that the station supports a dynamic host configuration protocol (DHCP) rapid commit protocol.

25. The apparatus of claim 24, wherein the set up message includes a DHCP discover message, and wherein the set up response includes a DHCP acknowledgement message indicating the assigned IP address.

26. An apparatus comprising:
means for receiving a set up message at an access point, the set up message requesting allocation of an internet protocol (IP) address to a station;
means for selecting an available IP address from a pool of available IP addresses to assign to the station based on the set up message;
means for assigning the available IP address to the station as an assigned IP address; and
means for transmitting a set up response to the station, the set up response identifying the assigned IP address.

27. The apparatus of claim 26, wherein the pool of available IP addresses corresponds to a portion of a memory coupled to the means for selecting the available IP address.

28. A non-transitory computer readable medium comprising instructions for fast internet protocol (IP) address assignment in a wireless communication network, the instructions, when executed by a processor at an access point, cause the processor to:
receive a set up message from a station, the set up message requesting allocation of an IP address to the station;
select an available IP address from a pool of available IP addresses to assign to the station based on the set up message;
assign the available IP address to the station as an assigned IP address; and
transmit a set up response to the station, the set up response identifying the assigned IP address.

29. The non-transitory computer readable medium of claim 28, wherein the set up message indicates that the station supports a dynamic host configuration protocol (DHCP) rapid commit protocol.

30. The non-transitory computer readable medium of claim 29, wherein the set up message includes a DHCP discover message, and wherein the set up response includes a DHCP acknowledgement message indicating the assigned IP address.
